(19) United States
(12) Patent Application Publication
(10) Pub. No.: US 2015/0373341 A1
(43) Pub. Date: Dec. 24, 2015

(54) Techniques for Interactive Region-Based Scalability

(71) Applicant: CISCO TECHNOLOGY, INC., SAN JOSE, CA (US)

(72) Inventor: Thomas Davies, Guildford (GB)

(21) Appl. No.: 14/311,741

(22) Filed: Jun. 23, 2014

(51) Int. Cl. H04N 19/187; H04N 19/44; H04N 19/119; H04N 19/167; H04N 19/139

(52) U.S. Cl. CPC H04N 19/187; H04N 19/167; H04N 19/139; H04N 19/119; H04N 19/44

(57) ABSTRACT

Techniques are provided herein for optimizing encoding and decoding operations for video data streams. An encoded video data stream is received, and select image segments of the encoded video data stream are identified. Each of the select image segments is an independently decodable portion of the encoded video data stream. Enhanced layer decoding operations are performed on each of the select image segments of the encoded video data stream to obtain an enhanced decoded output for the select image segments. Base layer decoding operations on each of the select image segments of the encoded video data stream are performed to obtain a base layer decoded output for the select image segments.

### TECHNICAL FIELD

The present disclosure relates to enhancing video data streams.

### BACKGROUND

In a video conference environment, endpoint devices may send and receive communications (e.g., video data streams) between each other. For example, endpoint devices may send video data streams directly to each other or via a video conference bridge. The video data streams may be encoded in multiple data layers. For example, the video data streams may be encoded in a base layer and in an enhancement layer. One or more layers of the video data streams may be decoded by an endpoint device before the video is presented.

### BRIEF DESCRIPTION OF THE DRAWINGS

FIG. 1 shows an example audio/video network environment featuring a transmitter endpoint device and a receiver endpoint device configured to perform optimized encoding and decoding operations, according to an example embodiment.

FIGS. 2A and 2B show a spatial representation of a video data stream with a plurality of interest regions for enhanced decoding, according to an example embodiment.

FIG. 3 shows an example point-to-point network environment featuring the transmitter endpoint device configured to determine regions of interest of a data frame and a receiver endpoint device configured to perform enhanced decoding for the region of interests, according to an example embodiment.

FIG. 4 shows an example transcoded network environment with a transmitter endpoint device, a plurality of receiver endpoint devices configured to perform enhanced decoding operations and a bridge device configured to facilitate exchange of video data streams in the network, according to an example embodiment.

FIG. 5 shows an example of a switched network conference environment with a transmitter endpoint device, a plurality of receiver endpoint devices configured to perform enhanced decoding operations and a media switch device configured to send enhanced data to the receiver endpoint devices, according to an example embodiment.

FIG. 6 shows a flow chart depicting operations for selecting a region of interest and performing enhanced encoding and decoding for the region of interest, according to an example embodiment.

FIG. 7 shows a flow chart depicting operations for performing enhanced decoding for a region of interest of a video data frame.

FIG. 8 shows an example block diagram of a device configured to perform the enhanced decoding operations, according to an example embodiment.

### DESCRIPTION OF EXAMPLE EMBODIMENTS

### Overview

Techniques are provided herein for optimizing encoding and decoding operations for video data streams. An encoded video data stream is received, and select image segments of the encoded video data stream are identified. Each of the select image segments is an independently decodable portion of the encoded video data stream. Enhancement layer decoding operations are performed on each of the select image segments of the encoded video data stream to obtain an enhanced decoded output for the select image segments. Base layer decoding operations on each of the select image segments of the encoded video data stream are performed to obtain a base layer decoded output for the select image segments.

### Example Embodiments

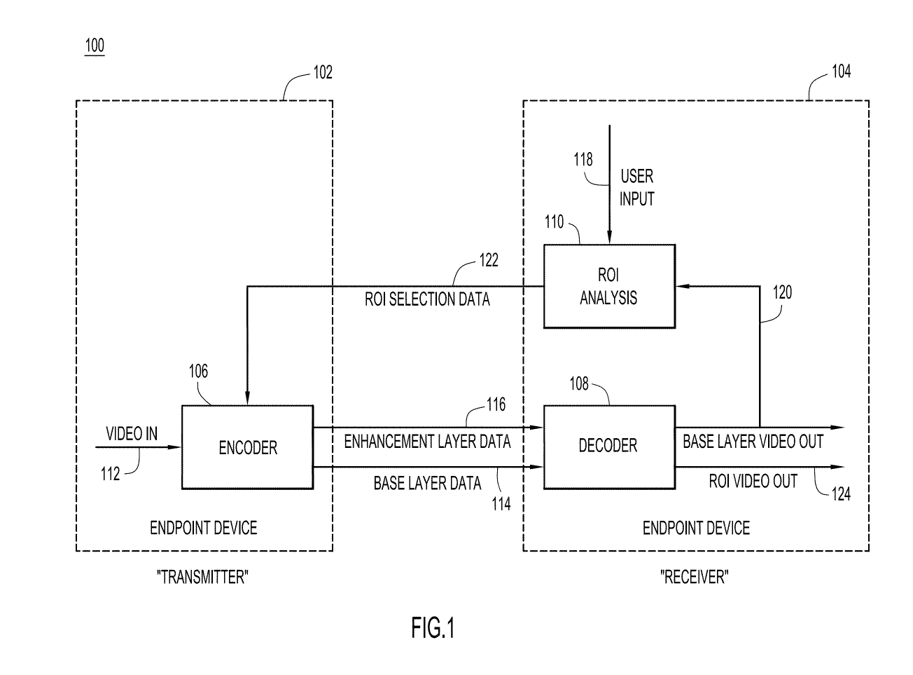

Techniques are presented herein for optimizing video data streams. An example audio/video network environment (“network”) is shown in FIG. 1 at reference numeral 100. The network 100 shows audio/video endpoint devices (“endpoint devices”) 102 and 104. Endpoint device 102 is shown as a transmitter device (“transmitter”) and endpoint device 104 is shown as a receiver device (“receiver”). It should be understood that endpoint device 104 also has transmit capabilities and likewise endpoint device 102 also has receive capabilities. However, for purposes of describing these techniques, communication flow is from endpoint device 102 as a source of information to endpoint device 104 as a destination of information. Thus, the term “transmitting endpoint device” refers to an endpoint device that is a source of video data to be sent to a receiving endpoint device, and a “receiving endpoint device” refers to an endpoint device that is a destination of video data from a source endpoint device. An endpoint device has the capability to be both a source and a destination of video data.

The endpoint device 102 and the endpoint device 104 may each service a plurality of participants (not shown in FIG. 1). The participants may be human or automated participants of an audio/video conference, and during the course of an audio/video conference session, the participants may communicate with one another via their respective endpoint devices. Likewise, the participants at one endpoint may be passive viewers of audio/video content. For example, the endpoint device 102 may send video data streams (comprising audio and video data frames) to the endpoint device 104. Participants at the endpoint device 104 may view a video corresponding to the video data streams (“video data”), for example, at a display (not shown in FIG. 1) at the endpoint device 104. The video, for example, may be image segments of an encoded video data stream. As will become apparent hereinafter, the participants may select certain portions of the video to be enhanced, and accordingly, the endpoint device 104 may perform enhanced decoding operation on the selected portions of the video.

FIG. 1 shows that the endpoint device 102 includes an encoder unit 106 and the endpoint device 104 includes a decoder unit 108 and a region of interest (ROI) analysis unit 110. In FIG. 1, the encoder unit 106 is hosted (e.g., as hardware or software) in the endpoint device 102 and the decoder unit 108 and the ROI analysis unit 110 are hosted (e.g., as hardware or software) in the endpoint device 104. It should be appreciated that this is merely an example. For example, as will become apparent hereinafter, the ROI analysis unit 110 may be hosted by the endpoint device 102. Additionally, there may be other units in the network 100 (e.g., a conference bridge device or media switch) that each may host one or more of the encoder unit 106, decoder unit 108 and ROI analysis unit 110. Again, as explained above, the endpoint device 102 also would include a decoder unit and a ROI analysis unit for processing video data received from the endpoint device 104, and the endpoint device 104 would have an encoder unit. For simplicity, FIG. 1 shows the components of the endpoint units 102 and 104 for information flow from endpoint device 102 to endpoint device 104.

As stated above, the endpoint device 102 may be configured to send encoded video data to the endpoint device 104. As such, FIG. 1 may be referred to as a point-to-point network environment with the ROI analysis unit 110 at the endpoint device 104. As shown in FIG. 1 at reference numeral 112, video data may be input to the encoder unit 106 at the endpoint device 102, and the input video data may be encoded by the encoder unit 106 to generate an encoded video data stream. The encoded video data stream may have multiple components or “layers.” That is, the encoded video stream may comprise multiple layers of compressed and encoded video data. The encoder unit 106 encodes these layers such that if one or more layers is removed or lost during transit to the endpoint device 104, the endpoint device 104 can still decode the received data to generate a viewable image/video. Such techniques may be referred to as Scalable Video Coding (SVC), such as that set forth in Annex G extension of the H.264/MPEG Advanced Video Coding (AVC) standard. For example, the encoder unit 106 may perform multi-layered encoding of the video data, including base layer encoding and enhanced layer encoding. Base layer encoding, in general, involves encoding the input video data with the most basic, scaled down image data needed to reconstruct the video (e.g., after decoding by the decoder unit 108 of the endpoint device 104). The remaining portions of the video data comprise enhancement layers, which contain information that the decoder unit 108 at the endpoint device 104 can use to scale up the video data and thus produce a higher quality image. If the decoder unit 108 (at the endpoint device 104) receives only the base layer encoded data, the decoder unit 108 can produce a video output, although the quality will fall short of the images that could be produced with the addition of enhancement layers. FIG. 1 shows the encoder unit 106 of the transmitter 102 sending to the decoder unit 108 of the endpoint device 104 base layer data, shown at reference numeral 114, and enhancement layer data, shown at reference numeral 116. Upon receiving the encoded video data, the decoder unit 108 may decode one or more of the layers, based on the techniques described herein. It should be appreciated that the base layer data and the enhancement layer data 116 may comprise the entire video data or may comprise selected portions of the video data, as described by the techniques here.

In general, the techniques described herein support enhanced quality for interactive spatial ROIs for image segments of video data. ROIs refer to specific portions of the image segments of video data for which participants (viewers of the video) are interested in receiving enhanced quality. For example, there may be some applications where at least two video views are presented to participants. A participant may wish to see, in one video view, an enhanced selected portion of a video, while in a second video view, may wish to see the entire video. For example, a teacher presenting an online lecture remotely may wish to have an overall first view of the class but also a zoomed-in high-quality second view of a student who is asking a question. In another example, some participants of a video conference may wish to see everyone in a room, while others may wish to see a zoomed-in image of a speaker. In a third example, when viewing large data set visualizations in a unified collaboration tool, a user may wish to zoom into certain areas of the data, and different participants (e.g., at different endpoints) may wish to zoom into different areas simultaneously.

Traditionally, using existing decoding techniques, the multiple views may be provided to participants by decoding both the base layer and enhancement layer of encoded video data to access these ROIs. In other words, participants may wish to view an enhance ROI in a video, and accordingly to existing decoding techniques, both the base layer for the entire video data and the enhancement layer of the entire video data may be decoded to simply provide the enhancements to the ROI, which may be a small portion of the entire video data.

The techniques described herein overcome these limitations by enabling a decoder unit to perform enhanced layer decoding operations on select image segments corresponding to a ROI. Thus, a participant can receive an enhanced view of a ROI without requiring decoding of the entire enhancement layer of the video data (e.g., image segments of the video data outside of the ROI).

For example, in FIG. 1, at reference numeral 118, a user (participant) sends an input to the ROI analysis unit 110 to select one or more ROIs of a base layer video. As stated above, the ROIs may correspond to one or more image segments of a video. The base layer video may be provided to the user and to the ROI analysis unit 110 by the decoder unit 108, as shown at 120. In other words, the decoder unit 108 may receive the base layer data from the encoder unit 106 and may decode only the base layer data (and not enhancement layer data, if provided by the encoder unit 106) to present a base layer video to the user. That is, as shown at 118, the user may select (e.g., using a mouse, keyboard, tactile selection mechanism, gesture-based or other user interface) for enhancement one or more ROIs of the base layer video. Based on the selected ROIs, at reference numeral 122, the ROI analysis unit 110 may send information to the encoder unit 106 that includes information of the selected ROIs (e.g., the image segments of the base layer video that correspond to the ROIs). In one example, the encoder unit 106, upon receiving the ROI selection data, may then send enhancement layer data corresponding to the ROIs (as shown at 116). In another example, the encoder unit 106 may send the enhancement layer data for the entire video to the decoder unit 108 and the decoder unit 108 may selectively decode portions of the enhanced video data that correspond only to the ROIs selected by the user. In this example, it should be appreciated that the encoder unit 106 also sends an indication to the decoder unit 108 as to which image segments (corresponding to ROIs) to decode. It should be appreciated that any other device in the network 100 (e.g., a device that generates the video data streams) may also send an indication to the decoder unit 108 as to which image segments to decode. Likewise, not shown in FIG. 1, the endpoint 104 may send to the encoder unit 106 a request message for enhancement layer data for image segments corresponding to an ROI. This request may be sent as a part of the ROI selection data 122. After performing the enhanced decoding operations, the decoder unit 108 outputs video data, with enhanced images for the ROI, as shown at reference numeral 124.

In the case of sending limited enhancement information, a region of interest is identified in the base layer consisting of a (probably rectangular) subset of the video data. The encoder may then use spatial predictions from just this region in order to encode the restricted enhancement information. The enhancement layer may be at the same or higher resolution than the region of interest in the base layer, and the type of enhancement may be of improved resolution or improved quality or both. In this case, it is possible that the entire base layer needs to be decoded, or special coding tools are used to avoid this. For example, if tiles are used in the base layer along with restrictions on the motion vectors used in the base layer, only the tiles covering the region of interest in the base layer need decoding. In the second case of decoding selected portions of a full enhancement layer, once again, if tiles, slices or similar segments are used at the encoder for the enhancement layer to determine an independently decodable region of a frame, and restrictions on motion vectors are used to make these independently decodable across a sequence of frames, then only portions of the enhancement layer need to be decoded. If these restrictions are implemented both at the base layer and the enhancement layer, then only portions of both need to be decoded. It should be understood that, as used herein, the term “image segments” may refer to tiles as defined in any video encoding standard now known or hereinafter developed, such as the MPEG HEVC/ITU-T H.265 standard, VP9 or similar technologies, or slices as defined in any video encoding standard now known or hereinafter developed, such as the MPEG AVC/ITU-T H.264, MPEG HEVC/ITU-T H.265 or similar technologies. Furthermore, select image segments may be identified for a region of interest of the encoded video data stream base on video and/or audio analysis, such as based on detection of a loudest speaker, in the classroom example, referred to above.

To elaborate, restrictions on motion vectors are needed because tiles/slices and similar segmentations break spatial dependencies within a frame, and allow data within a frame to be decoded independently from each other. However, frames are decoded with reference to previously-encoded frames also, by means of motion-compensated (i.e., displaced) prediction. The restrictions on the motion vectors are so that each tile depends only on data from within the co-located tile in previous frames. This makes a tile like a sub-stream of independently decodable video. Thus, select image segments may be identified such that they are independently decodable by virtue of restricting prediction to be from the same image segments in a current video frame or from a previously decoded video frame.

Thus, according to the present techniques, the base layer may be a spatial superset of the enhancement layer, and the ROIs that require enhancement may be smaller than the overall picture/image area of the base layer. As a result, it may be advantageous to perform enhanced decoding for only a small area of the image corresponding to the ROIs. These techniques are described herein.

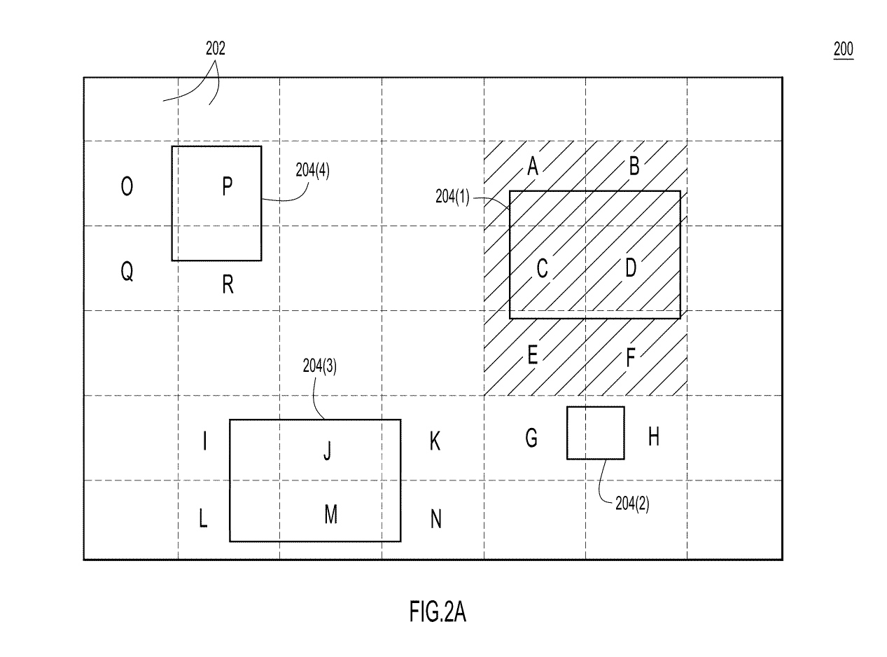

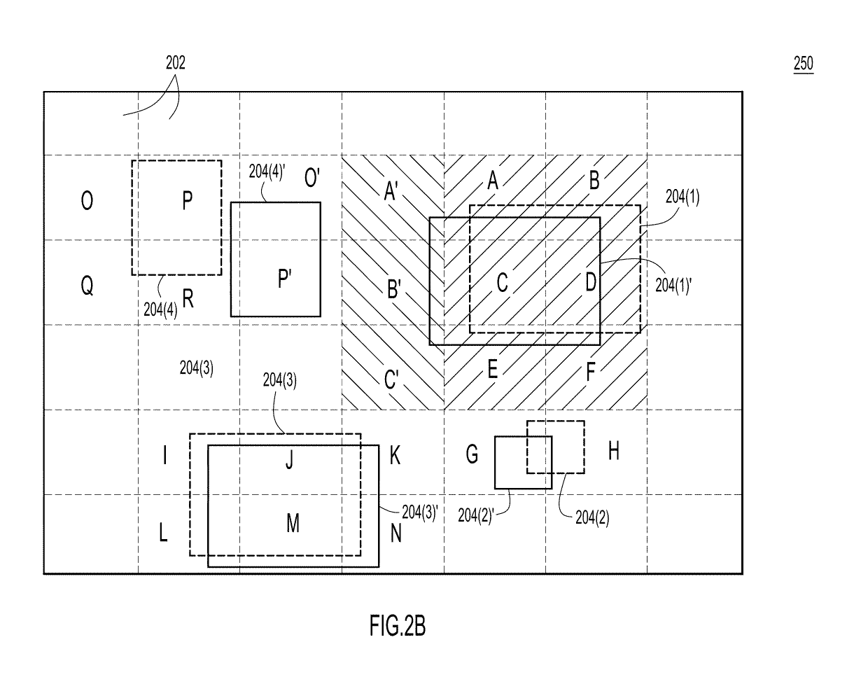

Reference is now made to FIGS. 2A and 2B. FIGS. 2A and 2B show a spatial representation of a video data stream with a plurality of ROIs for enhanced decoding. It should be appreciated that the spatial representations in FIGS. 2A and 2B may represent a video frame (video data frame) at a particular time instance of the video data. That is, the spatial representations in FIGS. 2A and 2B may represent a “snapshot” in time of the video data. In FIG. 2A, the spatial region 200 shows a plurality of image segments at reference numeral 202. The image segments 202 represent divided regions of the video frame, and each image segment is an independently encodable and decodable portion of the video frame. In other words, the image segments 202 may be thought of individually encodable and decodable tiles of the video frame, and in the example shown in FIG. 2A, the video frame in the spatial region 200 in FIG. 2A comprises 42 tiles arranged in a 7×6 configuration. The image segments can undergo enhanced encoding and decoding and can be spliced together to form a high-resolution ROI.

The spatial region 200 in FIG. 2A also has a plurality of ROIs at reference numeral 204(1)-204(4). As stated above, the ROIs may be selected by a user/participant using an appropriate interface device. As shown in FIG. 2A, the ROIs may cover different regions of a picture and may extend into regions defined by one or more of the image segments. For example, the ROI shown at reference numeral 204(1) covers a region of the video frame that overlaps with six image segments (shown at references A, B, C, D, E, and F in FIG. 2A). That is, if a selected portion of the ROI overlaps with any area of an image segment, no matter how small, the entire image segment is included as part of the select image segments for the ROI. Thus, for ROI 204(1), image segments A-F are considered as part of the select image segments even though the selected region of the ROI does not encompass the entirety of any one image segment. Similarly, ROI 204(2) has corresponding select image segments G and H, ROI 204(3) has corresponding select image segments I, J, K, L, M and N and ROI 204(4) has select image segments O, P, Q, and R. Thus, as described herein, enhanced decoding operations may be performed on image segments A-F only to produce the enhanced image for ROI 204(1). Likewise, enhanced decoding operations may be performed on image segments G and H for ROI 204(2), image segments I, J, K, L, M and N for ROI 204(3) and image segments O, P, Q, and R for ROI 204(4). In one example, base layer decoding operations may be performed on all of the image segments, while in another example, base layer decoding operations may be performed on for the select image segments.

To be clear, the base layer may not be segmented. An encoder may only segment the enhancement layer, and require decoding of the whole base layer. It is desirable to allow the encoder not to use techniques like tiles or slices in the base layer, since the base layer may be provided by some simpler legacy equipment and the more complex enhancement layer is an add-on that can be used without direct communication with or configuration of the legacy equipment.

FIG. 2B shows another spatial region 250 comprising the image segments 202. As is the case with FIG. 2A, FIG. 2B may represent a snapshot in time of video data (e.g., a video frame). In one example, the snapshot in FIG. 2B is at a time just after the snapshot in FIG. 2A. FIG. 2B shows modifications of the ROIs 204(1)-204(4) described in connection with FIG. 2A. Specifically, FIG. 2B shows in dashed lines ROIs 204(1)-204(4) in their previous positions represented by the snapshot of FIG. 2A and shows in solid lines new ROIs 204(1)′-204(4)′. The new ROIs 204(1)′-204(4)′ may represent, for example, motion of corresponding ROIs 204(1)-204(4) between the snapshot of FIG. 2A and the snapshot in FIG. 2B. The new ROIs 204(1)′-204(4)′ may occupy regions that correspond to image segments not previously occupied by ROIs 204(1)-204(4). Likewise, the new ROIs may no longer be present in regions that correspond to image segments occupied by ROIs 204(1)-204(4). For example, ROI 204(1)′ in FIG. 2B occupies (overlaps) image segments A′, B′ and A, B, C, D, E and F. ROI 204(2)′ in FIG. 2B overlaps image segments G and H (unchanged from ROI 204(2)), ROI 204(3)′ overlaps image segments I, J, K, L, M and N (unchanged from ROI 204(3)) and ROI 204(4) overlaps image segments P, R, O′ and P′ (and is no longer present in image segments O and Q). Thus, the new image segments may be decoded (e.g., using enhanced decoding techniques) by the decoder unit 108 (e.g., image segments A′, B′, C′, O′ and P′) in addition to the image segments previously occupied by ROIs 204(1)-204(4). As a result, an enhanced view of the moving ROI represented in FIGS. 2A and 2B may be seen. In one example, the decoder unit 108 may decode in the base layer only the image segments in the ROIs or alternatively may decode in the base layer every segment of the encoded video data stream (whether or not the image segment is in an ROI area). Where new image segments in the base layer or enhancement layers are required to be decoded they must be encoded with reference only to data the decoder has already received, or without reference to any prior data (i.e. intra coded).

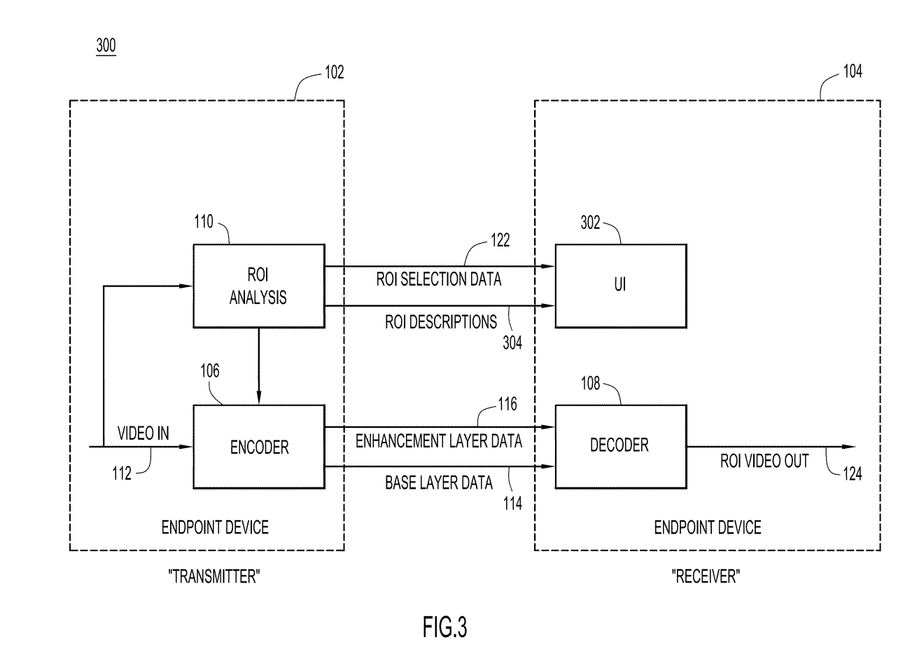

Reference is now made to FIG. 3, which shows an example point-to-point network 300. The network 300 includes the endpoint device 102 and the endpoint device 104. In the example of FIG. 3, the endpoint device 102 hosts the encoder unit 106 and also hosts the ROI analysis unit 110. The endpoint device 104 hosts the decoder unit 108. The endpoint device 104 also hosts a user interface (UI) unit 302. The UI unit 302, for example, is a keyboard, mouse, tactile detector or other known or contemplated user interface. The function of the UI is to allow a user to identify a desired region of interest, and this function may also be fulfilled by an automated process employing video analysis, gaze-tracking or artificial intelligence techniques, with no or only partial interaction with a human. In FIG. 3, the UI unit 302 from ROI analysis unit 110 receives, at 304, ROI descriptions (e.g., a set of information that designates one or more possible ROI selections). The ROI descriptions, for example, may be preset selections for various ROIs (e.g., preset regions within an image). The UI selects one or more ROIs and sends the selections to the ROI analysis unit 110, as shown at 122. The ROI analysis unit 110 sends the information to the encoder unit 106. The encoder unit 106 then sends the base layer data 114 and the enhancement layer data 116 to the decoder unit 108. Additionally, the encoder unit 106 may send to the decoder unit 108 information about the selected ROIs and associated image segments to enable the decoder unit 108 to perform enhanced decoding operations on the appropriate image segments. Thus, in FIG. 3, a user located at the receiver 104 may select the ROI even though the ROI analysis unit 110 is hosted by the transmitting endpoint device. Base layer data may be restricted to a spatial subset (since the ROI is known). The video input 112 is encoded by the encoder unit 106, and ultimately, the decoder unit 108 (at the receiver 104) outputs the video data at 124 with the enhanced ROI image segments.

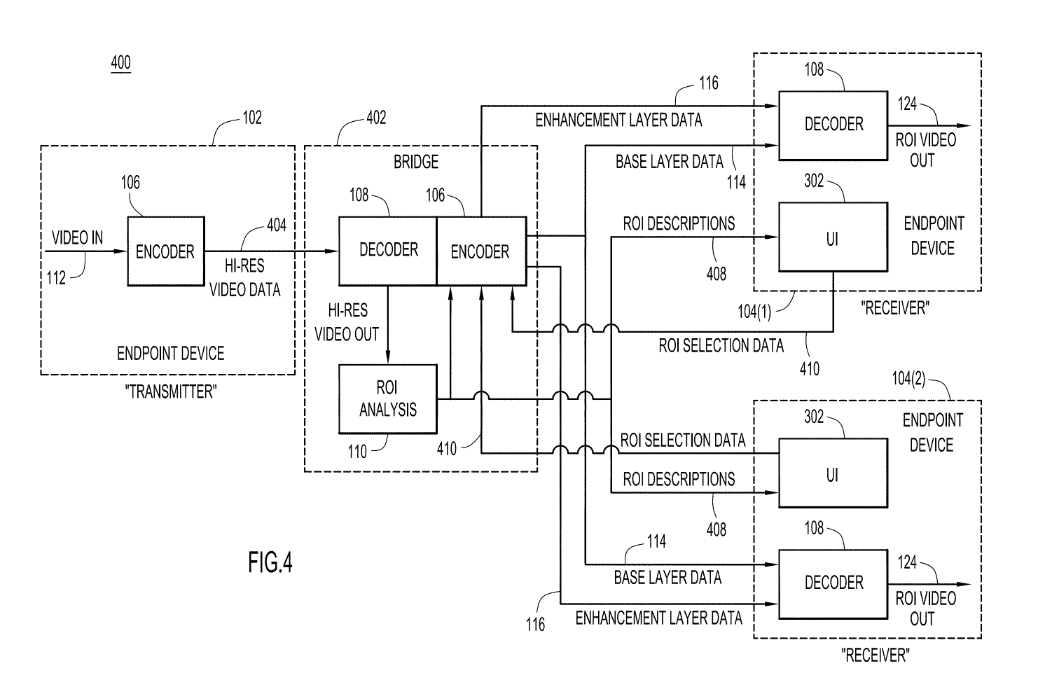

Reference is now made to FIG. 4. FIG. 4 shows an example network 400 with the transmitting endpoint device 102 and a plurality of receiving endpoint devices 104(1) and 104(2). The network 400 also includes a bridge device (bridge) 402. The endpoint device 102 has an encoder unit 102 that encodes input video data (shown at 112) to produce output high-resolution (hi-res) video data, as shown at 404 in FIG. 4. The bridge 402 is a device that is configured to send and receive the video streams to and from one or more of the endpoint devices. The bridge 104 has a decoder unit 108, an encoder unit 106 and an ROI analysis unit 110. Endpoint devices 104(1) and 104(2) each have a UI unit 302 and a decoder unit 108.

Upon receiving the encoded high-resolution video data, the decoder unit 106 of the bridge device 402, at 406, outputs high-resolution decoded data to the ROI analysis unit 110. The ROI analysis unit 110 sends, at 408, the ROI descriptions to the UI units 302 of each of the receiving endpoint devices 104(1) and 104(2). The ROI descriptions are similar to those described at reference numeral 304 in connection with FIG. 3. The UI units 302 (e.g., at the instruction of participants/users at respective receivers) each send ROI selection data to the ROI analysis unit 110, as shown at 410. The ROI selection data is similar to the ROI selection data 122 described in connection with FIGS. 1 and 3 above. After receiving the ROI selection data, the ROI analysis unit 110 sends the ROI selection data information to the encoder unit 108 of the bridge 402, and the encoder unit 108 sends base layer data 114 and enhancement layer data 116 to the decoder units 108 of the receiving endpoint devices 104(1) and 104(2). It should be appreciated that the enhancement layer data 116 sent to the decoder unit 108 of endpoint device 104(1) may be different than the enhancement layer data 116 sent to the decoder unit 108 of endpoint device 104(2), as users at endpoint device 104(1) and endpoint device 104(2) may select different ROIs. Thus, the decoder 108 of endpoint devices 104(1) and 104(2) may each decode the image segments corresponding to the selected ROIs and may output video data (shown at 124) with the enhanced ROI images. The network 400 in FIG. 4 may also be referred to as a transcoded conference scenario, where ROI analysis is performed on an intermediate device (e.g., bridge 402) and specific enhancement layers are sent to each receiver.

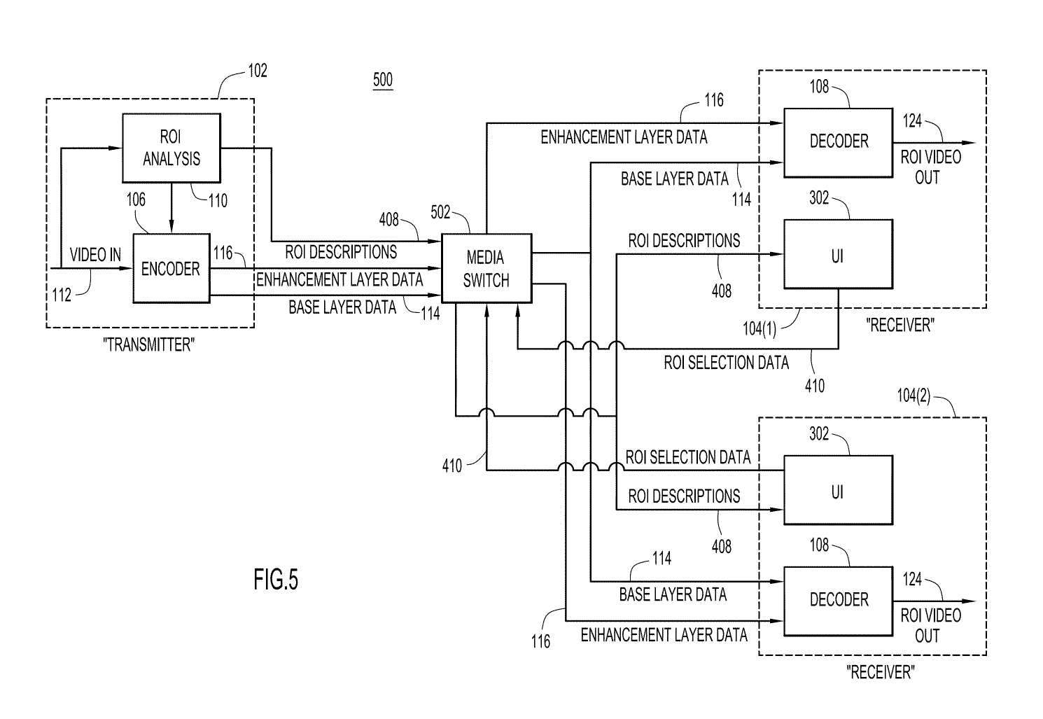

Reference is now made to FIG. 5. FIG. 5 shows an example network 500 depicting a transmitting endpoint device 102, a plurality of receiving endpoint devices 104(1) and 104(2) and a media switch device 502. The transmitting endpoint device 102 hosts the encoder unit 106 and the ROI analysis unit 110. The receiving endpoint devices 104(1) and 104(2) each host the decoder unit 108 and the UI unit 302. The media switch 502 is a switch device that is configured to forward video data to one or more of the receiving endpoint devices 104(1) and 104(2) (and specifically decoder units 108 of the receivers). In FIG. 5, the ROI analysis may be performed at the transmitting endpoint device 102. That is, the transmitting endpoint device 102 (e.g., a user) determines which ROIs are to be enhanced and sends base layer data 114, enhancement layer data 116 and ROI descriptions 408 to the media switch 502. The media switch 502 forwards the ROI descriptions 408 to the UI units 302 of the receiving endpoint devices 104(1) and 104(2) and at 410, the media switch 502 receives from the UI units 302 of the receiving endpoint devices 104(1) and 104(2) the ROI selection data (shown at 410). It should be appreciated that the ROI descriptions 408 and the ROI selection data 410 are similar to those described in connection with FIG. 4.

The media switch 502 then sends the appropriate base layer data 114 and enhancement layer data 116 to the decoder units 108 of the receiving endpoint devices 104(1) and 104(2). For example, the media switch 502 may send enhancement layer data 116 to the decoder unit 302 of receiving endpoint device 104(1) corresponding to the ROI selection performed by a user at receiving endpoint device 104(1). Likewise, the media switch 502 may send enhancement layer data 116 to the decoder unit 302 of receiving endpoint device 104(2) corresponding to the ROI selection performed by a user at receiving endpoint device 104(2).

As explained above, the ROI descriptions 408 are forwarded as shown in FIG. 5 when ROI analysis is performed at the transmitter, and there is signaling between the receivers and the transmitter as to whether ROI analysis is to be performed at the transmitter or locally at the respective receivers. The media switch 502 labels the streams for the appropriate receivers and passes them on. There is no need for the switch to do anything other than pass appropriately labeled data to the correct recipient (receiver). In all these multipoint scenarios it is possible for the receivers to decode the whole base layer and determine which ROIs are desired as described above in connection with FIG. 1, and to signal that to the transmitter, and so the ROI analysis may be performed at each receiver, thereby making it unnecessary for the transmission of ROI descriptions 408 from the transmitter.

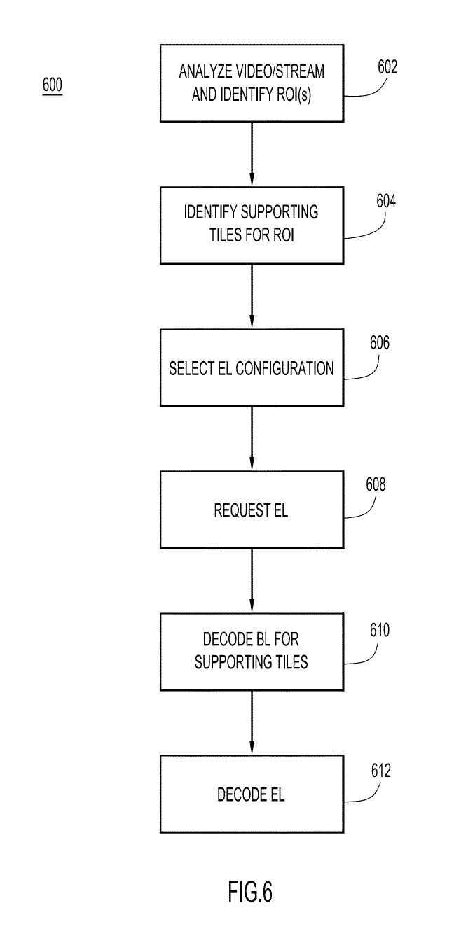

Reference is now made to FIG. 6. FIG. 6 shows an example flow chart 600 depicting operations for selecting a ROI and performing enhanced encoding and decoding for the ROI. At reference numeral 602, a UI device 302 or automated process analyzes a video stream and identifies one or more ROIs, possibly selected from a range of potential ROIs identified by an ROI analysis unit 110. The ROI analysis unit 110 may be hosted (in software or hardware components) by any endpoint device (e.g., transmitter 102 or receiver 104) or any intermediate device (e.g., the bridge 402 or media switch 502). At 604, the decoder unit identifies supporting tiles or image segments for the ROIs. For example, a tile or image segment may be specified by a cropping window within the base layer (e.g., origin in (x,y) coordinated and vertical and horizontal dimensions) together with a scaling ratio, if required. If the cropping window is aligned with coding block boundaries, then enhancements to quality and/or signal-to-noise would be possible. In one example, the image segments consist of a refinement layer of coefficients and from blocks in the base layer. Thus, the image segments cover different regions of an image to minimize the amount of decoding that is required at both the base layer and enhancement layer.

At 606, the decoder unit 108 selects an enhancement layer (EL) configuration and at 608 requests from an encoder unit (e.g., encoder unit 106 in FIGS. 1, 3, 4 and/or 5) the enhancement layer data corresponding to the image segments of the ROIs. At 610, the decoder unit 108 decodes the base layer for the image segments and at 612 decodes the enhancement layer for the image segments. After operation 612, the process reverts to operation 602.

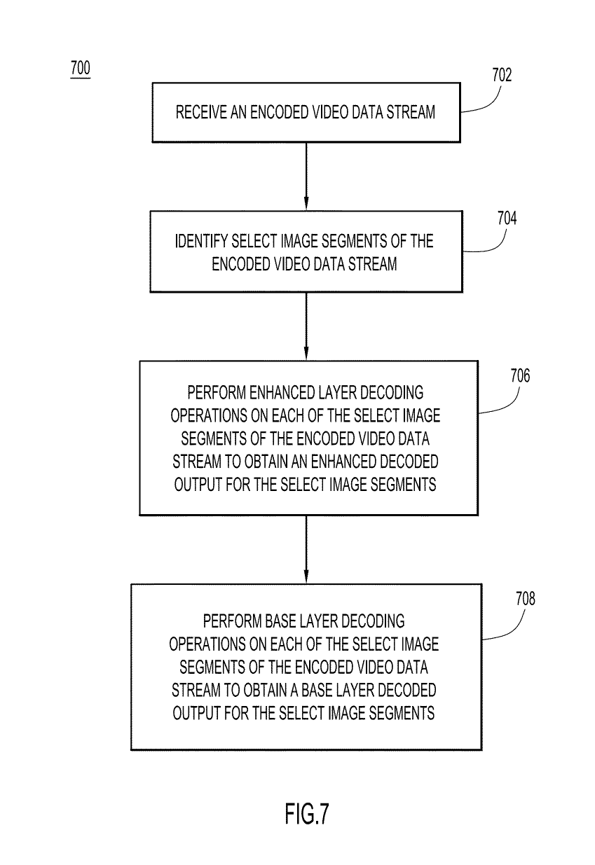

Reference is now made to FIG. 7, which shows an example flow chart 700 depicting operations for performing the enhanced decoding for a ROI of a video data frame. At 702, an encoded video data stream is received (e.g., by a decoder unit). At reference numeral 704, select image segments of the encoded video data stream are identified as covering the area identified as the ROI. Each of the select image segments is an independently decodable portion of the video data stream. At 706, enhanced layer decoding operations are performed on each of the select image segments of the encoded video data stream to obtain an enhanced decoded output for the select image segments. At 708, base layer decoding operations are performed on each of the select image segments of the encoded video data stream to obtain a base layer decoded output for the select image segments.

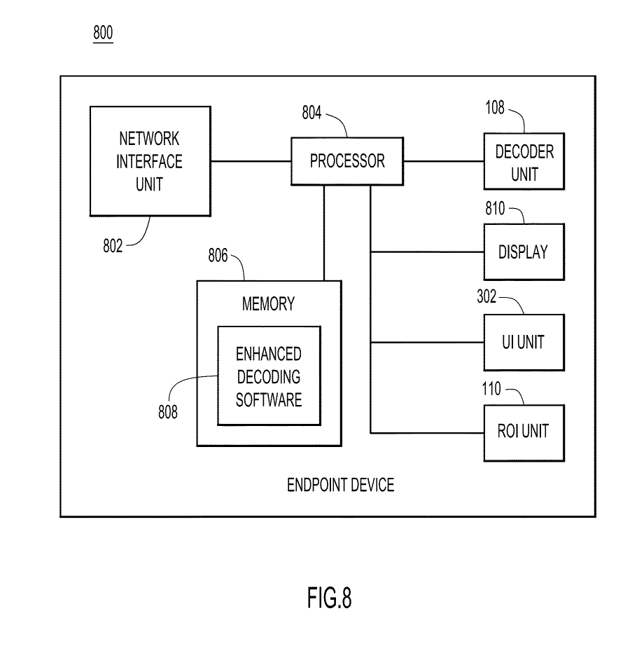

Reference is now made to FIG. 8. FIG. 8 shows an example block diagram of a device, such as a video conference endpoint device, configured to perform the enhanced decoding operations. The device may be, for example, an endpoint device (e.g., transmitter 102 or receiver 104) or may be an intermediate device (e.g., bridge 402 or media switch 502). More generally, the device shown in FIG. 8 may be any device in which the decoding operations described herein may be performed, not limited to video conference devices or equipment. In general, the video conference endpoint device is shown at reference numeral 800 in FIG. 8. The video conference endpoint device 800 comprises a network interface unit 802, a processor 804, a decoder unit 108, a memory 806, a display 810, an ROI unit 110 and a UI 302. The network interface unit 802 sends and receives communications to devices as described herein. The network interface unit 802 is coupled to the processor 804. The processor 804 is, for example, a microprocessor or microcontroller that is configured to execute program logic instructions (i.e., software) for carrying out various operations and tasks of the video conference device 800. For example, the processor 804 is configured to execute enhanced decoding software 808 to enable a decoder unit 108 (implemented in hardware or in memory 806 of the video conference device 800) to perform enhanced decoding operations for image segments corresponding to one or more ROIs. The functions of the processor 804 may be implemented by logic encoded in one or more tangible computer readable storage media or devices (e.g., storage devices compact discs, digital video discs, flash memory drives, etc. and embedded logic such as an application specific integrated circuit, digital signal processor instructions, software that is executed by a processor, etc.).

The decoder unit 108 is coupled to the processor 804. The decoder unit 108 may be, for example a video codec hardware element of the video conference endpoint device 800 that performs video decoding operations, as described herein. The UI unit 302 and the ROI unit 110 are also coupled to the processor and are configured to perform the operations described herein. In one example, UI unit 302 (e.g., a mouse, keyboard, joystick, etc.) and the ROI unit 110 may be hardware elements of the video conference endpoint device 800. In another example, the UI unit 302 and the ROI unit 110 may be executable software components of the video conference endpoint device 800. It should be appreciated that the decoder unit 108, the UI unit 302 and the ROI unit 110 operate in the same manner with the same functions as described in connection with FIGS. 1-7 above. The display 810 is a video display unit (e.g., monitor, computer display, etc.) that is configured to display video images to a user/participant located at the video conference endpoint device 800.

The memory 806 may comprise read only memory (ROM), random access memory (RAM), magnetic disk storage media devices, optical storage media devices, flash memory devices, electrical, optical, or other physical/tangible (non-transitory) memory storage devices. The memory 806 stores software instructions for the enhanced decoding software 808. Thus, in general, the memory 806 may comprise one or more computer readable storage media (e.g., a memory storage device) encoded with software comprising computer executable instructions and when the software is executed (e.g., by the processor 804) it is operable to perform the operations described for the enhanced decoding software 808

The enhanced decoding software 808 may take any of a variety of forms, so as to be encoded in one or more tangible computer readable memory media or storage device for execution, such as fixed logic or programmable logic (e.g., software/computer instructions executed by a processor), and the processor 806 may be an ASIC that comprises fixed digital logic, or a combination thereof.

For example, the processor 804 may be embodied by digital logic gates in a fixed or programmable digital logic integrated circuit, which digital logic gates are configured to perform the enhanced decoding software 808. In general, the enhanced decoding software 808 may be embodied in one or more computer readable storage media encoded with software comprising computer executable instructions and when the software is executed operable to perform the operations described hereinafter.

It should be appreciated that the techniques described above in connection with all embodiments may be performed by one or more computer readable storage media that is encoded with software comprising computer executable instructions to perform the methods and steps described herein. For example, the operations performed by the endpoint devices and the intermediate devices may be performed by one or more computer or machine readable storage media (non-transitory) or device executed by a processor and comprising software, hardware or a combination of software and hardware to perform the techniques described herein.

In summary, a method is provided comprising: receiving an encoded video data stream; identifying select image segments of the encoded video data stream, wherein each of the select image segments is an independently decodable portion of the encoded video data stream; performing enhanced layer decoding operations on each of the select image segments of the encoded video data stream to obtain an enhanced decoded output for the select image segments; and performing base layer decoding operations on each of the select image segments of the encoded video data stream to obtain a base layer decoded output for the select image segments.

In addition, a computer readable storage media is provided that is encoded with software comprising computer executable instructions and when the software is executed operable to: obtain an encoded video data stream; identify select image segments of the encoded video data stream, wherein each of the select image segments is an independently decodable portion of the encoded video data stream; perform enhanced layer decoding operations on each of the select image segments of the encoded video data stream to obtain an enhanced decoded output for the select image segments; and perform base layer decoding operations on each of the select image segments of the encoded video data stream to obtain a base layer decoded output for the select image segments.

Furthermore, an apparatus is provided comprising: a decoder unit configured to decode an encoded video data stream; and a processor coupled to the decoder unit, and further configured to: identify select image segments of the encoded video data stream, wherein each of the select image segments is an independently decodable portion of the encoded video data stream; cause the decoder unit to perform enhanced layer decoding operations on each of the select image segments of the encoded video data stream to obtain an enhanced decoded output for the select image segments; and cause the decoder unit to perform base layer decoding operations on each of the select image segments of the encoded video data stream to obtain a base layer decoded output for the select image segments.

The above description is intended by way of example only. Various modifications and structural changes may be made therein without departing from the scope of the concepts described herein and within the scope and range of equivalents of the claims.

What is claimed is:

1. A method comprising:
receiving an encoded video data stream;
identifying select image segments of the encoded video data stream, wherein each of the select image segments is an independently decodable portion of the encoded video data stream;
performing enhanced layer decoding operations on each of the select image segments of the encoded video data stream to obtain an enhanced decoded output for the select image segments; and
performing base layer decoding operations on each of the select image segments of the encoded video data stream to obtain a base layer decoded output for the select image segments.

2. The method of claim 1, further comprising performing base layer decoding operations on every image segment of the encoded video data stream.

3. The method of claim 1, wherein identifying comprises receiving from a device that generates the encoded video data stream an indication of the select image segments.

4. The method of claim 3, wherein receiving comprises receiving the indication of the select image segments that represents at least one region of interest of the encoded video data stream.

5. The method of claim 4, wherein identifying comprises identifying the select image segments of the region of interest that identifies a spatial location for enhancement in an image of the encoded video data stream.

6. The method of claim 1, wherein receiving the encoded video data stream comprises receiving the encoded video data stream that comprises base layer encoded data and enhancement layer encoded data.

7. The method of claim 1, wherein receiving the encoded video data stream comprises receiving the encoded video data stream that comprises base layer encoded data; and further comprising:
after identifying the select image segments, requesting from a device that generates the encoded video data stream, enhancement layer encoded data for the select image segments of the encoded video data stream.

8. The method of claim 1, wherein performing the enhanced layer decoding operations comprises performing the enhanced layer decoding operations based on an enhancement decoding configuration.

9. The method of claim 1, wherein the image segments are tiles as defined in the MPEG HEVC/ITU-T H.265 standard, VP9 or similar technologies, or slices as defined in the MPEG AVC/ITU-T H.264, MPEG HEVC/ITU-T H.265 or similar technologies.

10. The method of claim 1, wherein identifying comprises identifying the select image segments such that they are independently decodable by virtue of restricting prediction to be from the same image segments in a current video frame or from a previously decoded video frame.

11. The method of claim 1, wherein identifying comprises identifying the select image segments that represent a region of interest of the encoded video data stream is based on video and/or audio analysis.

12. A computer readable storage media encoded with software comprising computer executable instructions and when the software is executed operable to:
obtain an encoded video data stream;
identify select image segments of the encoded video data stream, wherein each of the select image segments is an independently decodable portion of the encoded video data stream;
perform enhanced layer decoding operations on each of the select image segments of the encoded video data stream to obtain an enhanced decoded output for the select image segments; and
perform base layer decoding operations on each of the select image segments of the encoded video data stream to obtain a base layer decoded output for the select image segments.

13. The computer readable storage media of claim 12, further comprising instructions that are operable to perform base layer decoding operations on the every image segment of the encoded video data stream.

14. The computer readable storage media of claim 12, wherein the instructions that are operable to identify comprise instructions that are operable to receive an indication of the select image segments from a device that generates the encoded video data stream.

15. The computer readable storage media of claim 12, wherein the instructions that are operable to obtain comprise instructions that are operable to receive the indication of the select image segments that represents at least one region of interest of the encoded video data stream.

16. The computer readable storage media of claim 15, wherein the instructions that are operable to identify comprise instructions that are operable to identify the select image segments of the region of interest that identifies a spatial location for enhancement in an image of the encoded video data stream.

17. The computer readable storage media of claim 12, wherein the instructions that are operable to obtain comprise instructions that are operable to receive the encoded video data stream that comprises base layer encoded data and enhancement layer encoded data.

18. The computer readable storage media of claim 12, wherein the instructions that are operable to obtain comprise instructions that are operable to obtain the encoded video data stream that comprises base layer encoded data; and further comprising instructions operable to:
request from a device that generates the encoded video data stream, enhancement layer encoded data for the select image segments of the encoded video data stream after identifying the select image segments.

19. The computer readable storage media of claim 12, wherein the instructions that are operable to perform the enhanced layer decoding operations comprise instructions operable to perform the enhanced layer decoding operations based on an enhancement decoding configuration.

20. An apparatus comprising:
a decoder unit that decodes an encoded video data stream;
a processor coupled to the decoder unit, wherein the processor is configured to:
identify select image segments of the encoded video data stream, wherein each of the select image segments is an independently decodable portion of the encoded video data stream;
cause the decoder unit to perform enhanced layer decoding operations on each of the select image segments of the encoded video data stream to obtain an enhanced decoded output for the select image segments; and
cause the decoder unit to perform base layer decoding operations on each of the select image segments of the encoded video data stream to obtain a base layer decoded output for the select image segments.

21. The apparatus of claim 20, wherein the processor causes the decoder unit to perform base layer decoding operations on every image segment of the encoded video data stream.

22. The apparatus of claim 20, wherein the processor obtains an indication of the select image segments received from a device that generates the encoded video data stream.

23. The apparatus of claim 22, wherein the processor obtains the indication of the select image segments that represents at least one region of interest of the encoded video data stream.
